(19) United States
(12) Patent Application Publication
(10) Pub. No.: US 2024/0240857 A1
(43) Pub. Date: Jul. 18, 2024

(54) DRYING DEVICE

(71) Applicant: NGK INSULATORS, LTD., Nagoya-Shi (JP)

(72) Inventors: Takuya MATSUMOTO, Nagoya-Shi (JP); Takeshi KOMAKI, Nagoya-Shi (JP)

(73) Assignee: NGK INSULATORS, LTD., Nagoya-Shi (JP)

(21) Appl. No.: 18/410,085

(22) Filed: Jan. 11, 2024

(30) Foreign Application Priority Data
Jan. 13, 2023 (JP) 2023-003842

(51) Int. Cl. F26B 3/30; F26B 13/00; F26B 23/04

(52) U.S. Cl. CPC F26B 3/30; F26B 13/005; F26B 23/04

(57) ABSTRACT

A drying device configured to dry a resin film including a solvent, the drying device may include: a housing; a partition disposed in the housing and partitioning a space in the housing into a first space and a second space; a conveyor configured to convey the resin film in the first space; a first heater disposed in the second space and configured to radiate electromagnetic waves to the resin film being conveyed by the conveyor; and a window disposed in the partition and configured to allow the electromagnetic waves radiated from the first heater to penetrate therethrough. The first heater may be configured to radiate electromagnetic waves in a wavelength band below 4.0 μm to the resin film and to absorb electromagnetic waves in a wavelength band of at least 4.0 μm or more.

### CROSS-REFERENCE TO RELATED APPLICATION

The present application claims priority to Japanese Patent Application No. 2023-003842, filed on Jan. 13, 2023, the entire contents of which are incorporated herein by reference.

### TECHNICAL FIELD

The art disclosed herein relates to a drying device.

### BACKGROUND ART

For example, a solvent may be applied to a surface of a resin film when the resin film used for a separator of a lithium-ion battery is manufactured. In this case, it is necessary to dry the solvent on the resin film. For example, Japanese Patent Application Publication No. 2012-154584 describes a drying device for drying a resin film including a solvent. The drying device of Japanese Patent Application Publication No. 2012-154584 includes a conveyor that conveys the resin film and a heater configured to radiate far-infrared rays to the resin film which is being conveyed by the conveyor.

When the resin film including the solvent is dried by far-infrared rays radiated from the heater, heat from the heater may increase a temperature of the vicinity of the resin film. When an organic solvent is used as the solvent on the resin film, the solvent evaporated from the resin film may cause an explosion if a temperature of the vicinity of the resin film becomes too high. In the drying device described in Japanese Patent Application Publication 2012-154584, a heat insulation layer is provided between a heating layer where the heater is installed and an area where the resin film is conveyed (explosion-proof layer) to prevent explosion caused by the evaporated solvent. Air is circulated through the heat insulation layer to ventilate the inside of the heat insulation layer, and the inside of the heat insulation layer is suppressed from reaching a high temperature. Further, a window configured to allow the far-infrared rays to penetrate therethrough is installed between the heat insulation layer and the explosion-proof layer, and the far-infrared rays radiated from the heater can be radiated to the resin film through the heat insulation layer. By installing the heat insulation layer between the heating layer and the explosion-proof layer, the far-infrared rays radiated from the heater are radiated to the resin film, while the explosion-proof layer where the resin film is conveyed is suppressed from reaching a high temperature.

### DESCRIPTION

### Summary

In the drying device of Japanese Patent Application Publication No. 2012-154584, the heat insulation layer is provided between the heating layer and the explosion-proof layer. However, when the drying device is continuously operated, the far-infrared rays radiated from the heater gradually increases a temperature inside of the heat insulation layer, and the window installed between the heat insulation layer and the explosion-proof layer may also reach a high temperature. When the window becomes hot, the inside of the explosion-proof layer may also become hot via the window.

The disclosure herein discloses art for more suitably suppressing explosions caused by a solvent evaporating from a resin film.

In a first aspect of the technology disclosed herein, a drying device disclosed herein may be configured to dry a resin film including a solvent. The drying device may comprise: a housing; a partition disposed in the housing and partitioning a space in the housing into a first space and a second space; a conveyor configured to convey the resin film in the first space; a first heater disposed in the second space and configured to radiate electromagnetic waves to the resin film being conveyed by the conveyor; and a window disposed in the partition and configured to allow the electromagnetic waves radiated from the first heater to penetrate therethrough. The first heater may be configured to radiate electromagnetic waves in a wavelength band below 4.0 μm to the resin film and to absorb electromagnetic waves in a wavelength band of at least 4.0 μm or more.

### BRIEF DESCRIPTION OF DRAWINGS

FIG. 1 shows a schematic configuration of a drying device of a first embodiment.

FIG. 2 shows a cross-sectional view of a schematic configuration of a heater.

FIG. 3 shows a partially enlarged view for explaining a configuration of a window.

FIG. 4 shows a schematic configuration of a drying device of a second embodiment.

FIG. 5 shows a schematic configuration of a drying device of a third embodiment.

FIG. 6 shows a schematic configuration of a drying device of a fourth embodiment.

FIG. 7 shows a perspective view of a tubular member, heaters, and a resin film.

FIG. 8 shows a schematic configuration of another example of the drying device of the fourth embodiment.

### DETAILED DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved drying devices, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Some of the features characteristic to below-described embodiments will herein be listed. It should be noted that the respective technical elements are independent of one another, and are useful solely or in combinations. The combinations thereof are not limited to those described in the claims as originally filed.

In a first aspect of the technology disclosed herein, a drying device disclosed herein may be configured to dry a resin film including a solvent. The drying device may comprise: a housing; a partition disposed in the housing and partitioning a space in the housing into a first space and a second space; a conveyor configured to convey the resin film in the first space; a first heater disposed in the second space and configured to radiate electromagnetic waves to the resin film being conveyed by the conveyor; and a window disposed in the partition and configured to allow the electromagnetic waves radiated from the first heater to penetrate therethrough. The first heater may be configured to radiate electromagnetic waves in a wavelength band below 4.0 μm to the resin film and to absorb electromagnetic waves in a wavelength band of at least 4.0 μm or more.

In the aforementioned drying device, the first heater is configured to radiate electromagnetic waves in the wavelength band below 4.0 μm to the resin film and absorb electromagnetic waves in the wavelength band of at least 4.0 μm or more. By absorbing the electromagnetic waves in the wavelength band of at least 4.0 μm or more, the inside of the housing (i.e., the first space and the second space) is suppressed from becoming hot due to the electromagnetic waves radiated from the first heater, and the vicinity of the resin film is suppressed from reaching a high temperature. Due to this, the solvent evaporating from the resin film can be suppressed from becoming hot, and explosions caused by the solvent evaporating from the resin film can be prevented.

In a second aspect of the technology disclosed herein according to the first aspect, the first heater may further be configured to radiate electromagnetic waves in a wavelength band below 3.5 μm to the resin film and to absorb electromagnetic waves in a wavelength band of 3.5 μm or more.

In a third aspect of the technology disclosed herein according to the first or second aspect, the first heater may comprise: a heating element extending in a direction perpendicular to a conveying direction of the resin film; a first tube disposed around an outer periphery of the heating element and surrounding the heating element; and a second tube disposed around an outer periphery of the first tube and surrounding the first tube. The first tube and the second tube may be constituted of a material configured to absorb electromagnetic waves in a wavelength band of 4.0 μm or more. According to such a configuration, almost no electromagnetic waves in the wavelength band of 4.0 μm or more are radiated from the first heater, and only the electromagnetic waves in the wavelength band of below 4.0 μm can suitably be radiated.

In a fourth aspect of the technology disclosed herein according to any one of the first to third aspects, the first heater may be configured to radiate electromagnetic waves to the resin film, 80% or more of the electromagnetic waves being infrared energy in a wavelength band below 4.0 μm. According to such a configuration, the electromagnetic waves in the wavelength band below 4.0 μm can suitably be radiated to the resin film.

In a fifth aspect of the technology disclosed herein according to any one of the first to fourth aspects, the first heater may be configured to radiate electromagnetic waves including visible light and ultraviolet light to the resin film.

In a sixth aspect of the technology disclosed herein according to any one of the first to fifth aspects, the window may comprise a support frame and a transmissive body, the support frame being disposed on the partition, the transmissive body being supported by the support frame and configured to allow the electromagnetic waves radiated from the first heater to penetrate therethrough. A space between the support frame and the transmissive body may be sealed by a seal. According to such a configuration, the solvent evaporated from the resin film can be suppressed from migrating to the vicinity of the heater by virtue of the space between the support frame and the transmissive body being sealed by the seal. Although a surface of the first heater tends not to be heated to a high temperature, if the first heater is continuously operated over a long period of time, a temperature around the first heater becomes higher than the vicinity of the resin film. By suppressing migration of the solvent evaporated from the resin film to the vicinity of the first heater, explosions in the drying device can be prevented.

In a seventh aspect of the technology disclosed herein according to any one of the first to sixth aspects, the drying device may further comprise: a supply device configured to supply atmospheric gas to at least one of the first space and the second space; and an exhaust device configured to exhaust atmospheric gas from at least one of the first space and the second space. The supply device and the exhaust device may cause a greater negative pressure in the first space than in the second space. According to such a configuration, by making the first space to have a greater negative pressure than the second space, it becomes difficult for gas to migrate from the first space to the second space. This makes it difficult for the solvent evaporated from the resin film conveyed in the first space to migrate to the vicinity of the first heater disposed in the second space.

In an eighth aspect of the technology disclosed herein according to any one of the first to seventh aspects, the drying device may further comprise a supply port which is open into the second space and through which gas is blown toward the window. Since the electromagnetic waves continue to be directly radiated from the first heater to a surface of the window on the second space-side, the surface of the window on the second space-side could reach a high temperature. By blowing the gas onto the surface of the window on the second space-side, the surface temperature of the window can be lowered, and the first space on the resin film-side can be suppressed from reaching a high temperature due to the window becoming hot.

In a nineth aspect of the technology disclosed herein according to any one of the first to eighth aspects, the drying device may further comprise an exhaust port disposed in a lower surface of the housing and through which atmospheric gas in the first space is exhausted from a lower portion of the housing. According to such a configuration, the gas in the first space can be exhausted from the lower portion of the housing. The solvent on the resin film is often heavier than air when it evaporates. By exhausting the gas in the first space from the lower portion of the housing, the solvent that evaporated from the resin film can easily be exhausted from the housing.

In a tenth aspect of the technology disclosed herein according to any one of the first to eighth aspects, the drying device may further comprise a tubular member extending in a conveying direction of the resin film and configured such that the resin film is conveyed therein. The partition may be one of a plurality of partitions disposed in the housing. The partitions may constitute an upper surface and a lower surface of the tubular member. The window may be disposed in at least one of the upper surface and the lower surface. The first heater may be disposed near one of the upper surface and the lower surface so as to radiate the electromagnetic waves to the window disposed on the one of the upper surface and the lower surface. According to such a configuration as well, the gas migration between the first and second spaces can be suppressed, and the solvent evaporated from the resin film can be suppressed from migrating to the vicinity of the heater.

In an eleventh aspect of the technology disclosed herein according to any one of the first to eighth aspects, the window may be one of a plurality of windows. The windows may be disposed in the upper surface and the lower surface of the partitions. The drying device may further comprise a second heater disposed near the other of the upper surface and the lower surface so as to radiate the electromagnetic waves to the window disposed in the other of the upper surface and the lower surface. The second heater may have the same configuration as the first heater. According to such a configuration, both sides of the resin film conveyed in the first space can be radiated with the electromagnetic waves. Due to this, the resin film can be dried more efficiently.

### EMBODIMENTS

### First Embodiment

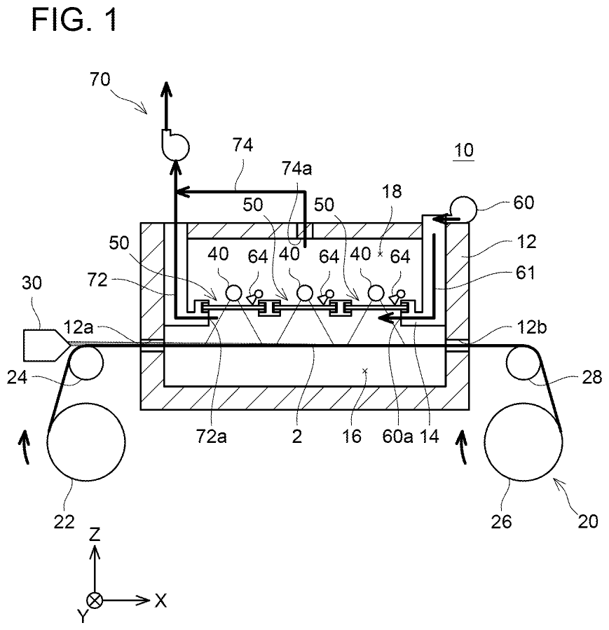

A drying device 10 will be described with reference to the drawings. The drying device 10 is used to dry a solvent applied to surface(s) of a resin film 2. In this embodiment, the resin film 2 is a polyethylene film or polypropylene film used in a separator of a lithium-ion battery. As shown in FIG. 1, the drying device 10 includes a furnace body 12, a conveyor 20, heaters 40, a supply device 60, an exhaust device 70, and supply nozzles 64.

The furnace body 12 has a substantially cuboid shape, and a partition 14 is disposed therein. The furnace body 12 and the partition 14 are constituted of nonferrous metals, such as aluminum alloy and stainless steel. The inner surface of the furnace body 12 may be polished to improve reflectivity of electromagnetic waves (to be described in detail later) radiated from the heaters 40. The partition 14 is arranged substantially parallel to the upper and lower surfaces of the furnace body 12, and divides a space inside the furnace body 12 into two spaces above and below each other. Hereinbelow, the space below the partition 14 is referred to as a first space 16 and the space above the partition 14 is referred to as a second space 18.

The conveyor 20 is configured to convey a resin film 2 in the first space 16. The conveyor 20 includes a feeding roller 22, a feeding guide roller 24, a winding roller 26, and a winding guide roller 28.

The feeding roller 22 has an unprocessed resin film 2 (more specifically, before a solvent is applied) wound thereon. The resin film 2 is fed from the feeding roller 22 and is wound onto the winding roller 26 via the feeding guide roller 24 and the winding guide roller 28. The feeding roller 22 and the winding roller 26 are rotated by motor(s) that are not shown. The resin film 2 is conveyed by rotation of the feeding roller 22 and the winding roller 26. Alternatively, only the winding roller 26 may be rotated by the motor(s).

The feeding roller 22 and the feeding guide roller 24 are disposed on the upstream side along a conveying direction of the resin film 2 (on the −X direction side in FIG. 1). The feeding roller 22 and the feeding guide roller 24 are disposed outside the furnace body 12. A through hole 12a is defined in a surface of the furnace body 12 on the side closer to the feeding roller 22 (surface on the −X direction side in FIG. 1). The through hole 12a connects the outside of the furnace body 12 with the first space 16. The resin film 2 supplied from the feeding roller 22 is fed out by the feeding guide roller 24 and is conveyed from the outside of the furnace body 12 to the inside thereof (in detail, into the first space 16) through the through hole 12a.

Further, a solvent application section 30 is disposed in the vicinity of the feeding guide roller 24. The solvent application section 30 is configured to apply the solvent to surface(s) of the resin film 2 (in FIG. 1, a top surface of the resin film 2) fed by the feeding guide roller 24. Thus, on the upstream side along the conveying direction of the resin film 2 (on the −X direction side in FIG. 1), the unprocessed resin film 2 is fed from the feeding roller 22, the solvent is applied to the surface of the resin film 2 by the solvent application section 30, and the resin film 2 with the solvent-coated surface is fed into the first space 16 through the through hole 12a by the feeding guide roller 24. The resin film 2 coated with the solvent is conveyed into the first space 16 through the through hole 12a, and is conveyed through the first space 16.

The winding roller 26 and the winding guide roller 28 are disposed on the downstream side along the conveying direction of the resin film 2 (on the +X direction side in FIG. 1). The winding roller 26 and the winding guide roller 28 are disposed outside the furnace body 12. A through hole 12b is defined in a surface of the furnace body 12 on the side closer to the winding roller 26 (surface on the +X direction side in FIG. 1). The through hole 12b connects the first space 16 with the outside of the furnace body 12. The resin film 2 fed from within the furnace body 12 (more specifically, from within the first space 16) to the outside through the through hole 12b is supplied to the winding roller 26 via the winding guide roller 28, and is wound onto the winding roller 26.

The resin film 2 is fed from the feeding roller 22, and after the solvent is applied to its surface at the solvent application section 30, it is conveyed through the drying device 10. While being conveyed through the drying device 10, the surface of the resin film 2 on which the solvent is applied is dried by electromagnetic waves radiated from the heaters 40 (to be described in detail later). When the surface of the resin film 2 on which the solvent is applied has dried, the resin film 2 is wound onto the winding roller 26 via the winding guide roller 28.

The heaters 40 are disposed in the second space 18. The heaters 40 are cylindrical and extend in a direction perpendicular to the conveying direction of the resin film 2 (Y direction in FIG. 1). The plurality of heaters 40 is spaced apart in the conveying direction of the resin film 2 (X direction in FIG. 1) in the second space 18.

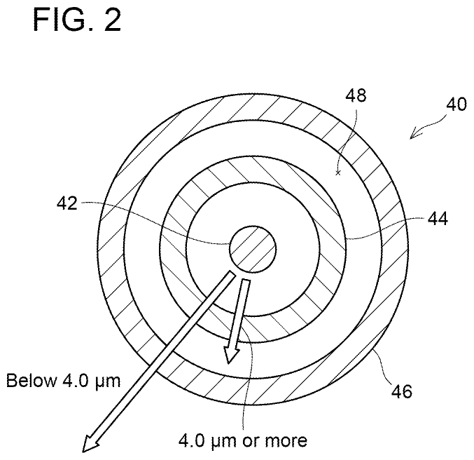

As shown in FIG. 2, each heater 40 has a heating element 42, an inner tube 44, and an outer tube 46. The heating element 42 is configured to radiate electromagnetic waves by heating that is performed by being electrically conducted.

The inner tube 44 covers the outer periphery of the heating element 42. The inner tube 44 is constituted of a material that allows electromagnetic waves in a wavelength band below 4.0 μm to penetrate therethrough and absorbs electromagnetic waves in a wavelength band of 4.0 μm or more. In this embodiment, the inner tube 44 is constituted of quartz. Of the electromagnetic waves radiated from the heating element 42, the electromagnetic waves in the wavelength band below 4.0 μm penetrate the inner tube 44, while the electromagnetic waves in the wavelength band of 4.0 μm or more are absorbed by the inner tube 44 and thus hardly penetrate therethrough. The electromagnetic waves in the wavelength band of 4.0 μm or more are absorbed by the inner tube 44, and the inner tube 44 is thereby heated. When the inner tube 44 is heated by the electromagnetic waves in the wavelength band of 4.0 μm or more, the inner tube 44 itself becomes a radiator of the electromagnetic waves in the wavelength band of 4.0 μm or more, and the electromagnetic waves in the wavelength band of 4.0 μm or more are radiated from the inner tube 44 as secondary radiation.

The outer tube 46 covers the outer periphery of the inner tube 44. The outer tube 46 is also constituted of the material that allows the electromagnetic waves in the wavelength band below 4.0 μm to penetrate therethrough and absorbs the electromagnetic waves in the wavelength band of 4.0 μm or more. In this embodiment, the outer tube 46 is also constituted of quartz. A cooling fluid (e.g., cooling gas) flows in a space 48 between the outer tube 46 and the inner tube 44.

When the inner tube 44 absorbs the electromagnetic waves in the wavelength band of 4.0 μm or more and is thereby heated, the electromagnetic waves in the wavelength band of 4.0 μm or more are secondarily radiated from the inner tube 44. The electromagnetic waves in the wavelength band of 4.0 μm or more that are secondarily radiated from the inner tube 44 are radiated to the space 48 between the inner tube 44 and the outer tube 46. By flowing the cooling fluid in the space 48 between the outer tube 46 and the inner tube 44, the inner tube 44 and the outer tube 46 can be cooled, and the temperatures of the inner tube 44 and the outer tube 46 can be suppressed from rising. The outer tube 46 absorbs the electromagnetic waves in the wavelength band of 4.0 μm or more, and as such, even if the electromagnetic waves in the wavelength band of 4.0 μm or more radiated to the space 48 between the inner tube 44 and outer tube 46 reach the outer tube 46, they are absorbed by the outer tube 46. Due to this, the electromagnetic waves in the wavelength band of 4.0 μm or more are not radiated to the outside the outer tube 46 (i.e., the outside of the heater 40). Thus, the electromagnetic waves in the wavelength band below 4.0 μm are radiated from the heater 40, and almost no electromagnetic waves in the wavelength band of 4.0 μm or more are radiated from the heater 40.

In this embodiment, the inner tube 44 and the outer tube 46 have the function of a low-pass filter that absorbs the electromagnetic waves in the wavelength band of 4.0 μm or more. In other words, most of the electromagnetic waves radiated from the heater 40 (i.e., the electromagnetic waves penetrating to the outside of the outer tube 46 disposed at the outermost circumference of this heater 40) are electromagnetic waves in the wavelength band below 4.0 μm, and a majority thereof is in a wavelength band below 3.5 μm. Specifically, 80% or more of the electromagnetic waves radiated from the heater 40 are infrared energy in the wavelength band below 4.0 μm, and 20% or less are infrared energy in the wavelength band of 4.0 μm or more. Most of the electromagnetic waves radiated from the heater 40 are electromagnetic waves in the wavelength band below 4.0 μm, but may also include visible light and/or ultraviolet light.

In this embodiment, since the majority of the electromagnetic waves radiated from each heater 40 is in the wavelength band below 4.0 μm, the outer surface of the heater 40 tend not to become hot as compared to heaters that do not block the electromagnetic waves in the wavelength band of 4.0 μm or more. Specifically, while a surface temperature of a heater that does not block the electromagnetic waves in the wavelength band of 4.0 μm or more exceeds 200° C., the surface temperature of each heater 40 in this embodiment is kept below 200° C. Due to this, the second space 18 where the heaters 40 are disposed can be suppressed from reaching a high temperature.

Further, in this embodiment, due to the electromagnetic waves in the wavelength band below 4.0 μm being radiated from the heaters 40, substances containing functional groups that tend to absorb the electromagnetic waves in the wavelength band below 4.0 μm (for example, O—H groups, N—H groups, C—H groups, etc.) can efficiently be evaporated. The solvent applied to the resin film 2 is often a substance containing functional groups that tend to absorb electromagnetic waves in the wavelength band below 4.0 μm. By radiating electromagnetic waves in the wavelength band below 4.0 μm from the heaters 40, the solvent applied on the resin film 2 can be efficiently evaporated. Since the majority of the electromagnetic waves radiated from the heaters 40 are in the wavelength band below 4.0 μm, the electromagnetic waves radiated from the heaters 40 are also referred to simply as “electromagnetic waves in the wavelength band below 4.0 μm” in the following.

The partition 14, which isolates the first space 16 from the second space 18, will now be described. As shown in FIG. 1, the partition 14 is disposed between the first space 16 and the second space 18. The partition 14 is provided with a plurality of windows 50. The windows 50 are provided in plurality along the conveying direction of the resin film 2, and the heaters 40 are each disposed in the vicinity of its corresponding window 50. The windows 50 are provided to radiate the electromagnetic waves radiated from the heaters 40 disposed in the second space 18 onto the resin film 2 being conveyed in the first space 16. Specifically, the partition 14 has a plurality of through holes 14a along the heaters 40, and the windows 50 are disposed in the through holes 14a.

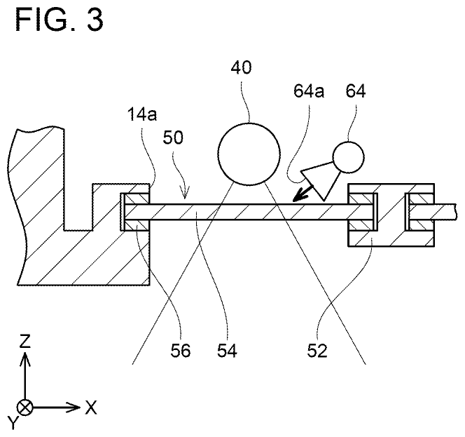

As shown in FIG. 3, each window 50 has a support frame 52, a glass plate 54, and a seal 56. The support frame 52 is provided in the through hole 14a. The support frame 52 is constituted of a nonferrous metal, such as an aluminum alloy or stainless steel, and supports the glass plate 54. The glass plate 54 is configured to allow the electromagnetic waves radiated from the heater 40 to penetrate therethrough, and allows the electromagnetic waves radiated from the heater 40 to penetrate from the second space 18 to the first space 16. As described above, the heater 40 radiates the electromagnetic waves in the wavelength band below 4.0 μm, so the electromagnetic waves transmitted through the glass plate 54 and radiated into the first space 16 are electromagnetic waves in the wavelength band below 4.0 μm. Since the furnace body 12 and partition 14 are constituted of nonferrous metal, they do not allow the electromagnetic waves radiated from the heater 40 to penetrate therethrough. Due to this, the electromagnetic waves are radiated to the first space 16 only through the glass plates 54. The electromagnetic waves in the wavelength band below 4.0 μm that have penetrated through the glass plates 54 are radiated to the resin film 2 that is conveyed in the first space 16. As a result, the solvent applied on the resin film 2 evaporates. In this embodiment, the glass plates 54 are used, however, such glass plates are not mandatory, and plates constituted of an inorganic material that contains hardly any O—H groups, such as quartz, alumina, or sapphire, for example, may be used. Using the plates constituted of the inorganic material that contains hardly any O—H groups allows the electromagnetic waves in the wavelength band below 4.0 μm to penetrate therethrough.

The seal 56 is positioned between the support frame 52 and the glass plate 54 to seal between the support frame 52 and the glass plate 54. By sealing between the support frame 52 and the glass plate 54 using the seal 56, gas migration between the first space 16 and the second space 18 can be suppressed. Since the solvent applied to the resin film 2 evaporates in the first space 16, the gas in the first space 16 contains the evaporated solvent. Organic solvents may be used as the solvent, and the gas of the evaporated solvent may be explosive at high temperatures. The heaters 40 are disposed in the second space 18. Since the heaters 40 in this embodiment radiate the electromagnetic waves in the wavelength band below 4.0 μm, the surface temperature of the heaters 40 tend not to reach a high temperature, however, if the heaters 40 continue to operate, the second space 18 where the heaters 40 are disposed becomes hot as compared to the first space 16 where the heaters 40 are not disposed. By sealing between the support frame 52 and the glass plate 54 by the seal 56, the gas generated by evaporation of the solvent in the first space 16 can be suppressed from migrating to the second space 18. This prevents the gas generated by evaporation of the solvent from exploding by being heated by the heaters 40 in the second space 18.

As shown in FIG. 1, the supply device 60 is configured to supply an atmospheric gas into the first space 16. Specifically, a supply port 60a of the supply device 60 is provided at a downstream position in the conveying direction of the resin film 2 (+X direction side in FIG. 1), and the supply device 60 supplies the atmospheric gas to the downstream side along the conveying direction of the resin film 2. In this embodiment, the supply device 60 supplies the atmospheric gas from the top surface of the furnace body 12, and the atmospheric gas flows through a supply path 61 provided along a surface of the furnace body 12 on the downstream side along the conveying direction of the resin film 2 (surface on the +X direction side in FIG. 1) and into the first space 16 from the supply port 60a.

The exhaust device 70 is configured to exhaust the atmospheric gas from within the furnace body 12. The exhaust device 70 includes a first exhaust flow path 72 and a second exhaust flow path 74.

The first exhaust flow path 72 is configured to discharge the atmospheric gas from within the first space 16 to the outside of the furnace body 12. Specifically, an exhaust port 72a at one end of the first exhaust flow path 72 opens to the first space 16 and is provided on the upstream side (−X direction side in FIG. 1) in the conveying direction of the resin film 2. The atmospheric gas in the first space 16 is discharged into the first exhaust flow path 72 from the exhaust port 72a on the upstream side in the conveying direction of the resin film 2. The first exhaust flow path 72 is provided along the surface of the furnace body 12 on the upstream side in the conveying direction of the resin film 2 (−X direction side in FIG. 1) and extends through the top surface of the furnace body 12 to the outside of the furnace body 12. Thus, the atmospheric gas in the first space 16 is exhausted from the first space 16 through the exhaust port 72a to the first exhaust flow path 72, and is discharged through the first exhaust flow path 72 to the outside of the furnace body 12 through the top surface of the furnace body 12. A volume of the atmospheric gas exhausted from the first exhaust flow path 72 is adjusted to be greater than a volume of the atmospheric gas supplied from the supply device 60. That is, external air is allowed to flow into the first space 16 through the through holes 12a and 12b.

The second exhaust flow path 74 is configured to exhaust the atmospheric gas from the second space 18 to the outside of the furnace body 12. Specifically, the exhaust port 74a of the second exhaust flow path 74 is defined in the top surface of the furnace body 12 to exhaust the atmospheric gas in the second space 18 from the top of the furnace body 12 to the outside thereof. The opposite end of the second exhaust flow path 74 from the exhaust port 74a connects with the first exhaust flow path 72 above the furnace body 12. The atmospheric gas in the second space 18 is exhausted from the second space 18 through the exhaust port 74a into the second exhaust flow path 74 and merges with the atmospheric gas exhausted from the first space 16 through the first exhaust flow path 72.

The supply device 60 supplies the atmospheric gas to the first space 16, and the exhaust device 70 exhausts the atmospheric gas from the first space 16. As a result, a flow of the atmospheric gas is generated in the first space 16 by the supply device 60 and the exhaust device 70. The supply device 60 supplies the atmospheric gas to the downstream side along the conveying direction of the resin film 2, and the exhaust device 70 exhausts the atmospheric gas from the upstream side along the conveying direction of the resin film 2. As a result, the atmospheric gas in the first space 16 flows in a direction opposite to the conveying direction of the resin film 2. In the first space 16, the solvent evaporates from the resin film 2. Since more solvent remains on the surface of the resin film 2 on the upstream side along the conveying direction of the resin film 2, a concentration of the solvent evaporated from the surface of the resin film 2 tends to be higher on the upstream side than on the downstream side in the conveying direction of the resin film 2. By flowing the atmospheric gas in the first space 16 in the direction opposite to the conveying direction of the resin film 2, it is possible to suppress the migration of gas containing a high concentration of solvent to the downstream side in the conveying direction of the resin film 2. Due to this, the gas containing the high concentration of the solvent can be suppressed from contacting the dried resin film 2 located on the downstream side, from which a large amount of solvent has already evaporated.

Further, the amount of atmospheric gas exhausted from the exhaust device 70 is greater than the amount of the atmospheric gas supplied from the supply device 60. As a result, a pressure inside the first space 16 becomes negative. In other words, the first space 16 comes to have a greater negative pressure than the second space 18. By causing a greater negative pressure in the first space 16 than in the second space 18, it becomes difficult for the gas to migrate from the first space 16 to the second space 18. As mentioned above, because the first space 16 and the second space 18 are separated by the seals 56 provided in the windows 50, gas does not normally migrate between the first space 16 and the second space 18. However, gas may become physically mobile between the first space 16 and the second space 18, for example, due to deterioration of the seal(s) 56 or breakage of the glass plate(s) 54. By causing a greater negative pressure in the first space 16 than in the second space 18, it becomes difficult for gas to migrate from the first space 16 toward the second space 18 even if the gas becomes mobile between the first space 16 and the second space 18. This more reliably prevents the gas containing the evaporated solvent in the first space 16 from moving into the second space 18 where the heater 40 is disposed.

The supply nozzles 64 are disposed in the second space 18. The supply nozzles 64 are disposed near the windows 50. The supply port 64a of each supply nozzle 64 opens toward the surface of its corresponding glass plate 54 (specifically, the surface on the second space 18 side), and the supply nozzle 64 blows the atmospheric gas onto the surface of the glass plate 54. In this embodiment, each supply nozzle 64 is disposed near the edge of the corresponding glass plate 54 on the +X direction side (downstream side in the conveying direction of the resin film 2), and blows the atmospheric gas from the downstream side toward the upstream side in the conveying direction of the resin film 2.

While the drying device 10 is operating, the glass plates 54 are continuously radiated with electromagnetic waves radiated from the heaters 40. As a result, the surfaces of the glass plates 54 on the heater 40 side (i.e., the surfaces on the second space 18 side) may become hot. If the surfaces of the glass plates 54 on the second space 18 side become hot, the entire glass plates 54 may become hot, and the first space 16 may thereby become hot through the glass plates 54. By blowing the atmospheric gas from the supply nozzles 64 onto the surfaces of the glass plates 54 on the second space 18 side, the temperature of the surfaces of the glass plates 54 on the second space 18 side, which tend to become hot, can be lowered. Due to this, the glass plates 54 can be prevented from becoming hot and the first space 16 can be suppressed from becoming hot through the glass plates 54.

### Second Embodiment

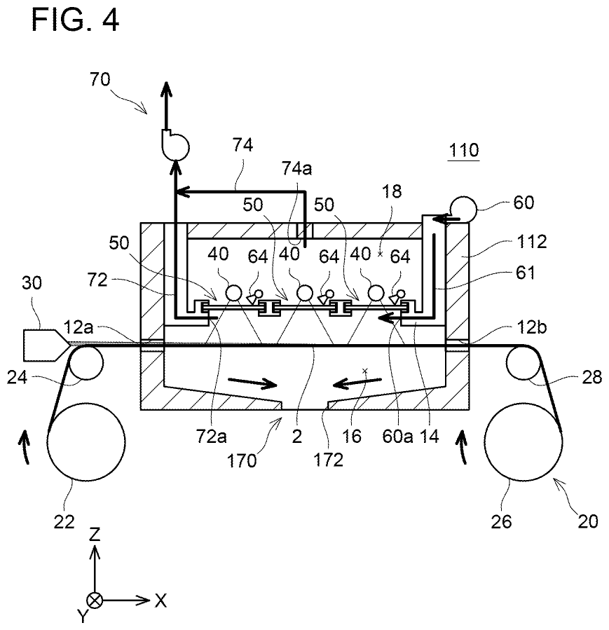

In the first embodiment as above, the drying device 10 includes the exhaust device 70 configured to discharge the atmospheric gas from its upper portion, however, the art disclosed herein is not limited to such a configuration. For example, as shown in FIG. 4, a drying device 110 may further include an exhaust device 170 configured to exhaust the atmospheric gas from its lower portion in addition to the exhaust device 70 configured to discharge the atmospheric gas from its upper portion. The drying device 110 in this embodiment has the exhaust device 170 added to the drying device 10 of first embodiment as above, and the other configurations are substantially identical to those of the drying device 10 of the first embodiment. For this reason, the exhaust device 170 will be described below. Since the drying device 110 of the present embodiment includes two exhaust devices 70, 170, the exhaust device 70 may hereafter be referred to as “first exhaust device 70” and the exhaust device 170 as “second exhaust device 170”.

The second exhaust device 170 is disposed at a lower portion of the furnace body 12. In this embodiment, an exhaust port 172 is provided on the lower surface of the furnace body 112. The second exhaust device 170 is configured to exhaust the atmospheric gas in the first space 16 from the exhaust port 172 to the outside of the furnace body 112. In this embodiment, the lower surface of the furnace body 112 (more specifically, the inner surface of the lower surface) is inclined such that the exhaust port 172 is disposed at the lowest point. The first space 16 contains a gas evaporated from the resin film 2. The gas evaporated from the resin film 2 is generally heavier than air, thus it moves downward in the first space 16. Due to the lower surface of the furnace body 12 being inclined toward the exhaust port 172, the gas evaporated from the resin film 2 can easily move toward the exhaust port 172, and the gas evaporated from the resin film 2 can easily be discharged through the exhaust port 172. Further, if the gas (solvent) evaporated from the resin film 2 liquefies again, the liquefied solvent can easily move toward the exhaust port 172, and the liquefied solvent can be suppressed from depositing in the furnace body 112.

### Third Embodiment

In the first and second embodiments as above, the resin film 2 is conveyed by the rollers 22, 24, 26, 28 disposed outside the furnace body 12, however, the art disclosed herein is not limited to such a configuration. For example, the resin film 2 may be supported and conveyed by conveying member(s) disposed inside the furnace body 12.

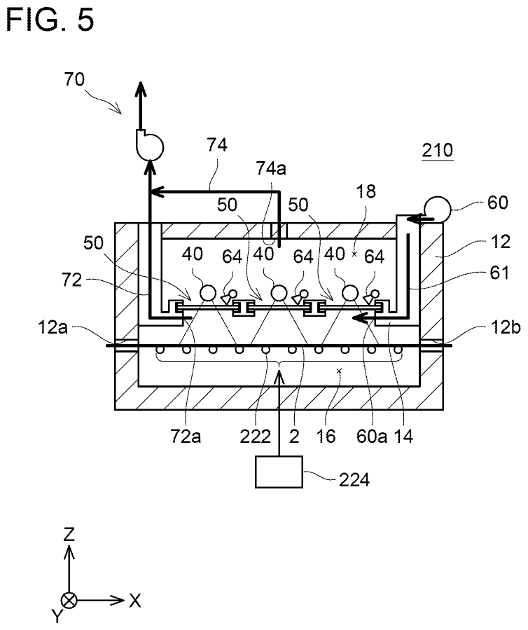

As shown in FIG. 5, a drying device 210 includes a conveyor (222, 224). The drying device 210 in this embodiment differs from the drying device 10 in first embodiment as above in that it has the conveyor (222, 224) instead of the conveyor 20, and the other configurations thereof are substantially identical. For this reason, the conveyor (222, 224) will be described below.

The conveyor (222, 224) includes a plurality of conveying rollers 222 and a drive unit 224. The plurality of conveyor rollers 222 is disposed in the first space 16 of the furnace body 12. The plurality of convey rollers 222 all has the same diameter and is equally spaced at a fixed pitch in the conveying direction (X direction in FIG. 5). The convey rollers 222 are supported to rotate around their axes and are rotated by the transmission of drive power from the drive unit 224. The drive unit 224 is a drive unit (e.g., a motor) that drives the convey rollers 222. The resin film 2 is placed on the convey rollers 222 and conveyed in the first space 16 by the convey rollers 222. Thus, the resin film 2 can be supported and conveyed within the first space 16. In this embodiment, the drying device 210 includes only the first exhaust device 70, however, it may include both the first exhaust device 70 and the second exhaust device 170.

In this embodiment, the resin film is conveyed while being supported by the convey rollers 222, however, the art disclosed herein is not limited to such a configuration. For example, instead of the convey rollers 222, a belt disposed within the first space 16 may be used to convey the resin film 2. Even if the belt is used to convey the resin film 2, the resin film 2 can likewise be conveyed while being supported in the first space 16.

### Fourth Embodiment

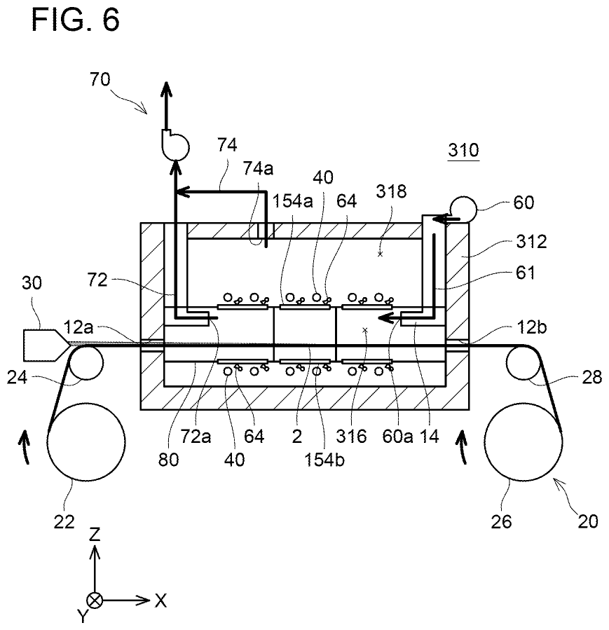

In the above first to third embodiments, the first space 16 and the second space 18 are separated by the partition 14 fixed at the center of the furnace body 12, however, the art disclosed herein is not limited to such a configuration. For example, as shown in FIG. 6, a first space 316 and a second space 318 may be separated by installing tubular members 80 in a furnace body 312. A drying device 310 of this embodiment differs from the drying device 10 of first embodiment above in that the tubular members 80 separate the first space 316 and the second space 318, and the other configurations are substantially identical. For this reason, the configuration of the tubular members 80 will be described below.

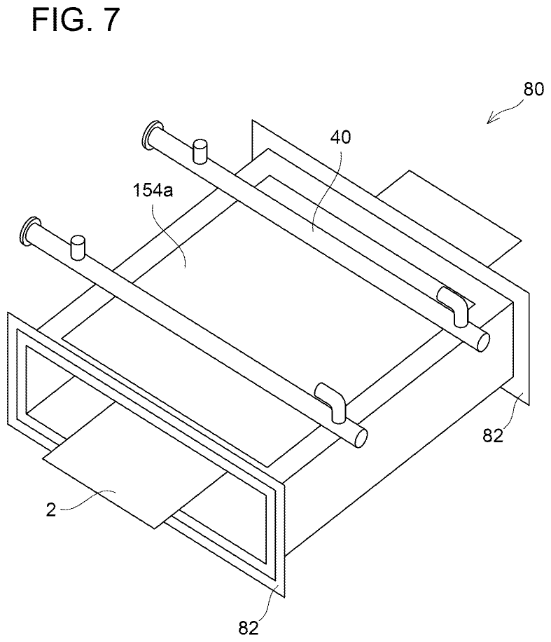

As shown in FIGS. 6 and 7, each of the tubular members 80 has a cuboid shape with openings at both ends, and its axis extends in the conveying direction (X direction in FIG. 6). The tubular member 80 has openings on the inlet side and the outlet side in the conveying direction. The openings of the tubular member 80 on the inlet and outlet sides are provided with flanges 82. A plurality of tubular members 80 is continuously connected in the furnace body 312 in the conveying direction, and the flanges 82 of adjacent tubular members 80 are sealed.

The tubular member 80 has a glass plate 154a fitted into the upper surface and a glass plate 154b fitted into the lower surface. Specifically, support frames (not shown) are formed on the upper and lower surfaces of the tubular member 80, and the glass plates 154a and 154b are supported by the support frames. The support frames and the glass plates 154a and 154b are sealed by seals (not shown).

The heaters 40 and the supply nozzles 64 are disposed near the top surfaces and near the bottom surfaces of the tubular members 80. In FIG. 7, the supply nozzles 64 and the glass plate 154b on the lower side are omitted for easier understanding of the drawing. The heaters 40 extend in the direction perpendicular to the conveying direction. A plurality of heaters 40 is disposed in the furnace body 312 with the heaters 40 spaced apart from each other in the conveying direction. In this embodiment, two heaters 40 are disposed near one glass plate 154a. The number of heaters 40 disposed in the vicinity of one glass plate 154a is not particularly limited. The heaters 40 and the supply nozzles 64 have the same configuration as the heaters 40 and the supply nozzles 64 in the first embodiment above, thus the detailed explanation will be omitted.

In this embodiment, the heaters 40 are disposed near the upper surfaces and near the lower surfaces of the tubular members 80. Due to this, the first space 316 in the tubular members 80 is radiated with the electromagnetic waves from above and also from below. In other words, the resin film 2 conveyed through the first space 316 in the tubular members 80 is radiated with electromagnetic waves from above and also from below. Due to this, the solvent applied on the resin film 2 can be evaporated in a shorter time, and the length of the furnace body 312 in the conveying direction can be shortened.

The sealing between the support frames and the glass plates 154a, 154b in this embodiment prevents the gas migration between the first space 316 inside the tubular members 80 and the second space 318 inside the furnace body 312 and outside the tubular members 80. The space between the flanges 82 of the two adjacent tubular members 80 is also sealed. This also prevents the gas migration between the first space 316 and the second space 318 from between the adjacent tubular members 80. The resin film 2 is conveyed in the first space 316 inside the tubular members 80, and the heaters 40 are disposed in the second space 318 outside the tubular members 80. The gas is prevented from moving between the first space 316 and the second space 318, thereby preventing the gas generated by evaporation of the solvent in the first space 316 from moving into the second space 318.

In this embodiment, the drying device 310 uses the tubular members 80 to separate the first space 316 in which the resin film 2 is conveyed and the second space 318 in which the heaters 40 are disposed. The solvent that has evaporated from the resin film 2 moves downward in the first space 316 and may liquefy again. By conveying the resin film 2 in the tubular members 80, deposition of the liquefied solvent on the bottom surface of the furnace body 312 can be avoided. Further, by defining the first space 316 with the tubular members 80, the cross-sectional area of the first space 316 in the direction perpendicular to the conveying direction can be reduced. This makes it easier to control the first space 316 to have a negative pressure. Further, by reducing the cross-sectional area of the first space 316 in the direction perpendicular to the conveying direction, the flow velocity of the atmospheric gas generated by the supply device 60 and the exhaust device 70 can be increased. This makes it easier to exhaust the gas in the first space 316 and easier to exhaust the solvent evaporated from the resin film 2.

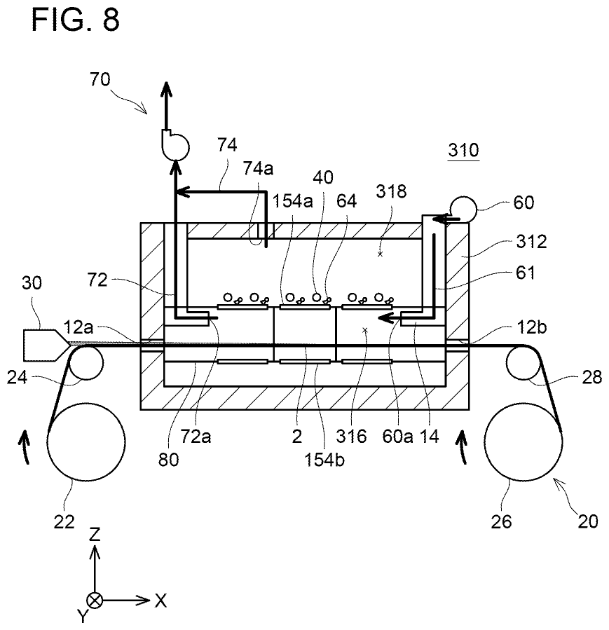

In this embodiment, the heaters 40 are disposed both above and below the tubular members 80, however, the art disclosed herein is not limited to such a configuration. For example, as shown in FIG. 8, the heaters 40 may be disposed only above the tubular members 80 and not below the tubular members 80. A drying device 410 in FIG. 8 differs from the drying device 310 in FIG. 7 only in that the heaters 40 are not disposed below the tubular members 80, and the other configurations are substantially identical. With the drying device 410 as well, the deposition of the liquefied solvent on the bottom of the furnace body 312 can be avoided, and it becomes easier to cause the first space 316 to have a negative pressure and to exhaust the solvent evaporated from the resin film 2. Alternatively, unlike the example shown in FIG. 8, the heater may be disposed only below the tubular members 80 and not above the tubular members 80.

The followings are some notes on the drying device 10 described in the embodiments. The furnace body 12, 112, 312 of the embodiments is an example of “housing”, the inner tube 44 is an example of a “first tube,” the outer tube 46 is an example of a “second tube,” the glass plate 54 is an example of a “transmissive body,” the supply port 64a of the supply nozzle 64 is an example of a “supply port”, and the exhaust port 172 is an example of an “exhaust port”.

Specific examples of the disclosure herein have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the purpose of the examples illustrated by the present description or drawings is to satisfy multiple objectives simultaneously, and satisfying any one of those objectives gives technical utility to the present disclosure.

What is claimed is:

1. A drying device configured to dry a resin film including a solvent, the drying device comprising:
a housing;
a partition disposed in the housing and partitioning a space in the housing into a first space and a second space;
a conveyor configured to convey the resin film in the first space;
a first heater disposed in the second space and configured to radiate electromagnetic waves to the resin film being conveyed by the conveyor; and
a window disposed in the partition and configured to allow the electromagnetic waves radiated from the first heater to penetrate therethrough,
wherein the first heater is configured to radiate electromagnetic waves in a wavelength band below 4.0 μm to the resin film and to absorb electromagnetic waves in a wavelength band of at least 4.0 μm or more.

2. The drying device according to claim 1, wherein the first heater is further configured to radiate electromagnetic waves in a wavelength band below 3.5 μm to the resin film and to absorb electromagnetic waves in a wavelength band of 3.5 μm or more.

3. The drying device according to claim 1, wherein
the first heater comprises:
a heating element extending in a direction perpendicular to a conveying direction of the resin film;
a first tube disposed around an outer periphery of the heating element and surrounding the heating element; and
a second tube disposed around an outer periphery of the first tube and surrounding the first tube, and
the first tube and the second tube are constituted of a material configured to absorb electromagnetic waves in a wavelength band of 4.0 μm or more.

4. The drying device according to claim 1, wherein the first heater is configured to radiate electromagnetic waves to the resin film, 80% or more of the electromagnetic waves being infrared energy in a wavelength band below 4.0 μm.

5. The drying device according to claim 1, wherein the first heater is configured to radiate electromagnetic waves including visible light and ultraviolet light to the resin film.

6. The drying device according to claim 1, wherein
the window comprises a support frame and a transmissive body, the support frame being disposed on the partition, the transmissive body being supported by the support frame and configured to allow the electromagnetic waves radiated from the first heater to penetrate therethrough, and
a space between the support frame and the transmissive body is sealed by a seal.

7. The drying device according to claim 1, further comprising:
a supply device configured to supply atmospheric gas to at least one of the first space and the second space; and
an exhaust device configured to exhaust atmospheric gas from at least one of the first space and the second space,
wherein the supply device and the exhaust device cause a greater negative pressure in the first space than in the second space.

8. The drying device according to claim 1, further comprising a supply port which is open into the second space and through which gas is blown toward the window.

9. The drying device according to claim 1, further comprising an exhaust port disposed in a lower surface of the housing and through which atmospheric gas in the first space is exhausted from a lower portion of the housing.

10. The drying device according to claim 1, further comprising a tubular member extending in a conveying direction of the resin film and configured such that the resin film is conveyed therein,
wherein
the partition is one of a plurality of partitions disposed in the housing,
the partitions constitute an upper surface and a lower surface of the tubular member,
the window is disposed in at least one of the upper surface and the lower surface, and
the first heater is disposed near one of the upper surface and the lower surface so as to radiate the electromagnetic waves to the window disposed on the one of the upper surface and the lower surface.

11. The drying device according to claim 10, wherein
the window is one of a plurality of windows,
the windows are disposed in the upper surface and the lower surface of the partitions,
the drying device further comprises a second heater disposed near the other of the upper surface and the lower surface so as to radiate the electromagnetic waves to the window disposed in the other of the upper surface and the lower surface, and
the second heater has the same configuration as the first heater.
